(19) United States
(12) Patent Application Publication
(10) Pub. No.: US 2019/0311594 A1
(43) Pub. Date: Oct. 10, 2019

(54) CONTAINER FOR LITHIUM BATTERY

(71) Applicant: Kidde Technologies, Inc., Wilson, NC (US)

(72) Inventors: Robert J. Norris, Wilson, NC (US); Terry Simpson, Wake Forest, NC (US)

(21) Appl. No.: 15/949,627

(22) Filed: Apr. 10, 2018

(51) Int. Cl. G08B 17/10; H01M 2/10; H01M 2/12

(52) U.S. Cl. CPC G08B 17/10; H01M 2220/10; H01M 2/1264; H01M 2/1055

(57) ABSTRACT

A battery container includes a battery housing and an end cap. The battery housing is configured to house a battery. The battery housing comprises an opening configured to receive the battery into the battery housing. The end cap is configured to seal the opening of the battery housing. The end cap comprises two or more discharge holes configured to release expanding gas from the battery housing.

### BACKGROUND

In certain aircraft applications aircraft electrical power is not readily available, and sensing equipment relies on internal battery power. One example of this is a stand-alone smoke detector situated in an aircraft cargo container. Lithium and other battery technologies have particularly good specific power density, enabling them to provide power for months to years. However, the specific power density of lithium batteries can cause the battery to enter thermal runaway if compromised by mechanical damage and/or internal or external short circuiting. Battery thermal runaway results in damage to stand-alone smoke detectors.

### SUMMARY

In one example, a battery container comprises a battery housing and an end cap. The battery housing is configured to house a battery. The battery housing comprises an opening configured to receive the battery into the battery housing. The end cap is configured to seal the opening of the battery housing. The end cap comprises two or more discharge holes configured to release expanding gas from the battery housing.

In one example, a smoke detector comprises a battery container, a circuit board, battery leads, and a smoke detector case. The battery container comprises a battery housing and an end cap. The battery housing is configured to house a battery. The battery housing comprises an opening configured to receive the battery into the battery housing. The end cap is configured to seal the opening of the battery housing. The end cap comprises two or more discharge holes configured to release expanding gas from the battery housing. The circuit board includes smoke detector electronics. The battery leads are electrically coupled to the battery container and the circuit board. The smoke detector case houses the battery container, the circuit board, and the battery leads.

### BRIEF DESCRIPTION OF THE DRAWINGS

FIG. 1 is a cross-sectional view of an aircraft fuselage.

FIG. 2 is a partially exploded perspective view of a smoke detector.

FIG. 3 is a partially transparent second perspective view of the smoke detector.

FIG. 4 is a block diagram of the smoke detector.

### DETAILED DESCRIPTION

Apparatus, systems, and associated methods relate to preventing fire, explosion, and/or damage caused by battery thermal runaway. In some applications, such as smoke detection of aircraft cargo carriers, aircraft devices rely on battery power. In these cases, aircraft devices and surrounding structures can be subject to damage caused by battery thermal runaway. Using the apparatus, systems, and associated methods herein, allows for the use of batteries with high specific power densities without risk of fire, explosion, and damage. The smoke detectors include non-flammable sealed battery containers with discharge holes to allow the discharge of expanding gases. During thermal runaway electrolyte is discharged harmlessly through the discharge holes, thereby preventing explosions and fire.

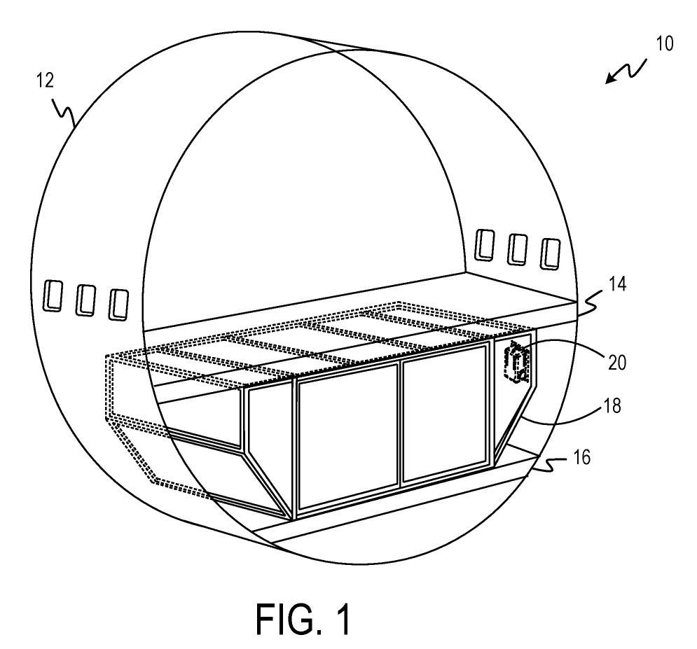

FIG. 1 is a cross-sectional view of aircraft fuselage 10 including fuselage frame 12, cabin floor 14, cargo floor 16, aircraft cargo container 18, and smoke detector 20.

Aircraft cargo container 18 is designed to store cargo in a shape that fits the cargo area of aircraft between cabin floor 14, cargo floor 16, and fuselage frame 12. This shape prevents aircraft cargo container 18 and cargo it may contain from shifting within aircraft, causing weight shifts that affect aircraft flight. Smoke detector 20 is mechanically coupled to the inside of aircraft cargo container 18 to detect smoke from potential fires within aircraft cargo container 18.

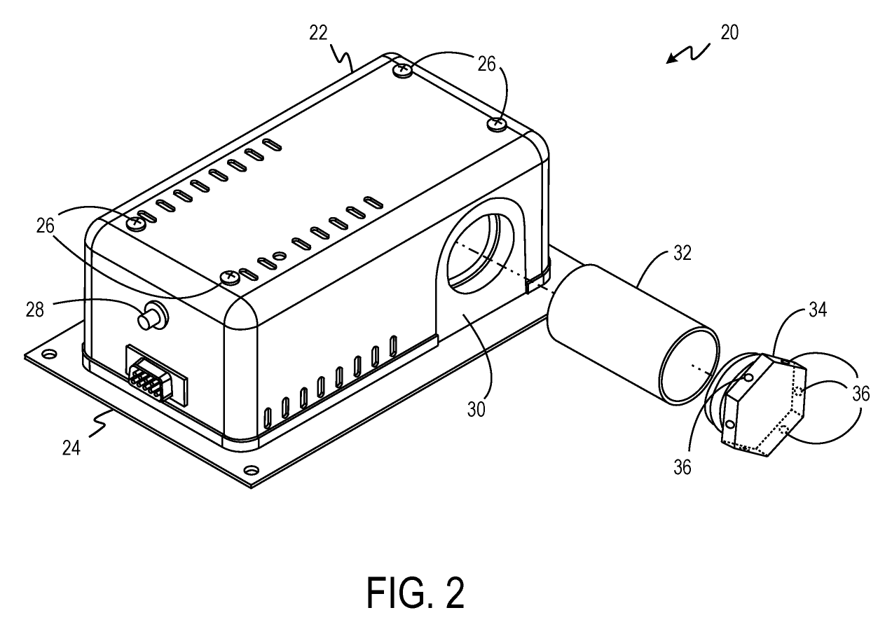

FIG. 2 is a partially exploded perspective view of a smoke detector 20 including smoke detector case 22, baseplate 24, fasteners 26, press-to-test button 28, battery housing 30, battery 32, end cap 34, and discharge holes 36.

Smoke detector case 22 is mechanically coupled to baseplate 24 by fasteners 26. Baseplate 24 can be mechanically coupled to the interior of an aircraft cargo container such as aircraft cargo container 18 of FIG. 1. Smoke detector case 22 protects internal circuitry from being damaged by external sources such as cargo of an aircraft cargo container. Push-to-test button 28 allows a user to test the operability of the smoke detector by pressing push-to-test button 28. Battery housing 30 is made of lightweight non-flammable material. In one example, battery housing 30 and end cap 34 are made of steel. End cap 34 seals battery 32 in battery housing 30. End cap 34 threads into the opening of battery housing 30. Battery housing 30 provides protection for battery 32 from sources of mechanical damage. Battery housing 30 also provides protection to smoke detector 20 and cargo from battery 32 in case of thermal runaway. In one example, battery housing 30 is at least partially formed of conductive material to provide positive and negative electrical connections to battery 32. In one example, battery housing 30 is mechanically coupled to baseplate 24. In a further example, battery housing 30 is monolithically formed with baseplate 24.

Battery 32 is a lithium battery. Lithium batteries provide the benefit of a higher specific power density than sodium-ion, silver-zinc, nickel-cadmium, or other battery types. When lithium batteries are compromised by mechanical damage, internal shorting, and/or external shorting, thermal runaway can occur. Thermal runaway is an exothermic chemical reaction with a positive feedback loop. The exothermic reaction releases heat, which acts as a catalyst speeding up the chemical reaction, which in turn releases more heat, causing an exponential temperature increase. Thermal runaway can result in electrolyte breakdown, fire, and/or explosions. To prevent electrolyte breakdown, fire, and/or explosions, battery housing 30 is made of non-flammable material and end cap 34 includes discharge holes 36.

Battery housing 30 and end cap 34 form a battery container. Discharge holes 36 vent electrolyte of battery 32 during thermal runaway. Discharge holes allow expanding electrolyte to escape from battery housing 30 without causing an explosion. In one example, discharge holes 36 are formed on flat perimeter surfaces of end cap 34. Discharge holes 36 are arranged in diametrically opposed pairs so that the force experienced by end cap 34 from electrolyte escaping from holes 36 is effectively zero. This prevents end cap 34 from accelerating and becoming a dangerous projectile. With only a single discharge hole, or an arrangement of holes that provide a force on end cap 34, end cap 34 could accelerate and may break the battery container. In one example, end cap 34 can have n discharge holes spaced 360/n degrees apart. Arranged in this manner, discharge holes 36 will effectively exert zero force on end cap 34. In another example, discharge holes 36 are composed of one or more diametrically opposed pairs of discharge holes. In one example, discharge holes 36 are discharge valves that allow fluid flow in one direction.

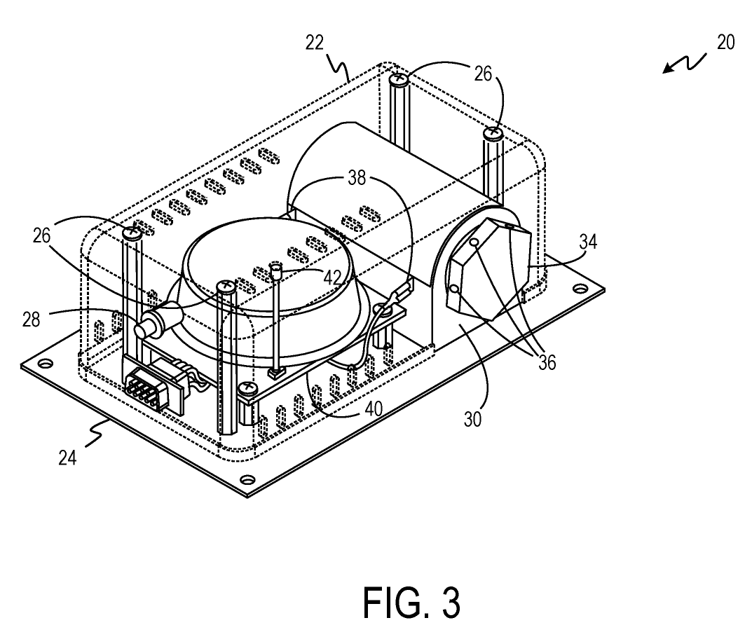

FIG. 3 is a perspective view of a smoke detector 20 including smoke detector case 22, baseplate 24, fasteners 26, press-to-test button 28, battery housing 30, end cap 34, discharge holes 36, battery leads 38, circuit board 40, and status light emitting diode (LED) 42. As shown in FIG. 3 smoke detector case 22 is illustrated transparently to show battery leads 38, circuit board 40, and status light emitting diode (LED) 42.

Battery leads 38 provide power from battery 32 to circuit board 40. Circuit board 40 contains the components necessary for smoke detector 20 to function as a smoke detector. Status LED 42 is electrically coupled to circuit board 40. Status LED 42 receives power from circuit board 40.

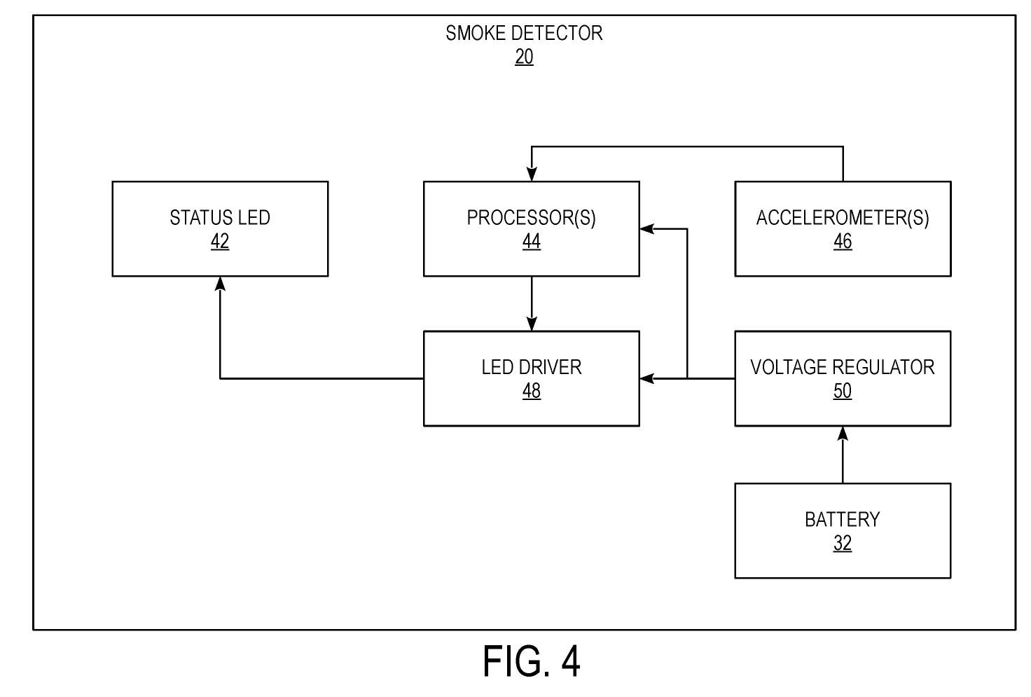

FIG. 4 is a block diagram of smoke detector 20 including battery 32, status LED 42, processor(s) 44, accelerometer(s) 46, LED driver 48, and voltage regulator 50. For purposes of clarity and ease of discussion, FIG. 4 is discussed with respect to smoke detector 20 of FIGS. 2 and 3.

Battery 32 is electrically coupled to voltage regulator 50 via battery leads 38 and circuit board 40. Voltage regulator 50 regulates the voltage of the power provided by battery 32 to appropriate voltages for processor(s) 44 and LED driver 48. Processor(s) 44 can be a microprocessor, microcontroller, or other processors. Accelerometer(s) 46 sense movement and/or vibration of smoke detector 20. Accelerometer(s) 46 sense movement and/or vibration when on a moving aircraft or a moving aircraft cargo container. Accelerometer(s) 46 provides a sensor signal to processor(s) 44 representative of the sensed movement and/or vibration. Processor(s) 44 sets a blinking rate of status LED 42 based upon the sensor signal. Processor(s) 44 determines if the sensed movement exceeds a threshold based upon the sensor signal. Processor(s) 44 sets the blinking rate of status LED 42 to a first blinking rate if the sensed movement/vibration is equal to or less than the threshold. Processor(s) 44 sets the blinking rate of status LED 42 to a second blinking rate if the movement/vibration exceeds the threshold. The first blinking rate is faster than the second blinking rate. Press-to-test button 28 is configured to set the blinking rate of status LED 42 to the first blinking rate even when the sensed movement exceeds a threshold. In one example, press-to-test button 28 is configured to set the blinking rate of status LED 42 to a third blinking rate. The third blinking rate can be faster than the first blinking rate. Processor(s) 44 provides control signals to LED driver 48. LED driver 48 provides power to status LED 42 based upon the blinking rate. In one example the first blinking rate is once every five seconds and the second blinking rate is once every twenty seconds.

Many design/certification authorities require a continuously blinking light to provide a positive indication of smoke detector function. However, during ground transportation or flight, smoke detector 20 is out of sight and is not subject to visual status inspections because the aircraft cargo container containing smoke detector 20 is closed. At these times, battery 32 provides power to status LED 42 even though status LED 42 cannot be seen. At these times, a slower rate of blinking drains less power which extends battery life of battery 32. In one example, battery life of battery 32 is extended by 20%.

Accordingly, implementing techniques of this disclosure, battery containers of aircraft smoke detectors can prevent fires, explosions, and other damage using non-flammable materials and discharge holes. Using battery containers as described herein provides the ability to discharge battery electrolyte harmlessly during thermal runaway. This eliminates the risk of fire and prevents explosions caused by thermal runaway because a main source of heat and explosion, battery electrolyte, is discharged from the battery case.

### Discussion of Possible Embodiments

The following are non-exclusive descriptions of possible embodiments of the present invention.

A battery container can comprise a battery housing configured to house a battery, the battery housing comprising an opening configured to receive the battery into the battery housing; and an end cap configured to seal the opening of the battery housing, the end cap comprising two or more discharge holes configured to release expanding gas from the battery housing.

The battery container of the preceding paragraph can optionally include, additionally and/or alternatively, any one or more of the following features, configurations and/or additional components:

The two or more discharge holes can comprise at least one pair of diametrically opposed discharge holes.

The two or more discharge holes can be spaced equally along a perimeter of the end cap such that the radial spacing between each of the two or more discharge holes is equal.

The battery housing can be comprised of non-flammable material.

The two or more discharge holes can be configured to release expanding electrolyte of the battery.

The opening of the battery housing can be the only opening of the battery housing.

The battery housing can be comprised of steel.

The discharge holes can be formed at flat perimeter surfaces of the end cap.

A smoke detector can comprise a battery container comprising a battery housing configured to house a battery, the battery housing comprising an opening configured to receive the battery into the battery housing; and an end cap configured to seal the opening of the battery housing, the end cap comprising two or more discharge holes configured to release expanding gas from the battery housing; a circuit board including smoke detector electronics; battery leads electrically coupled to the battery container and the circuit board; and a smoke detector case to house the battery container, the circuit board, and the battery leads.

The smoke detector of the preceding paragraph can optionally include, additionally and/or alternatively, any one or more of the following features, configurations and/or additional components:

The two or more discharge holes can comprise at least one pair of diametrically opposed discharge holes.

The two or more discharge holes can be spaced equally along a perimeter of the end cap such that the radial spacing between each of the two or more discharge holes is equal.

The battery housing can be comprised of non-flammable material.

The two or more discharge holes can be configured to release expanding electrolyte of the battery.

The opening of the battery housing can be the only opening of the battery housing.

The two or more discharge holes can be configured to release expanding gas external to the smoke detector case.

A baseplate mechanically coupled to the smoke detector case, the baseplate configured to be mechanically coupled to an aircraft cargo container.

The battery housing can be mechanically coupled to the baseplate.

The battery housing can be formed monolithically to the baseplate.

The battery housing can be comprised of steel.

The discharge holes can be formed at flat perimeter surfaces of the end cap.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A battery container for a battery that is replaceable within the battery container, the battery container comprising:
a battery housing configured to house the battery, the battery housing comprising an opening configured to allow the battery to be inserted into and removed from the battery housing; and
an end cap configured to seal the opening of the battery housing, the end cap comprising two or more discharge holes configured to release expanding gas from the battery housing with the two or more discharge holes being formed through flat perimeter surfaces on sides of the end cap and spaced equally along the perimeter surfaces such that the radial spacing between each of the two or more discharge holes is equal.

2. The battery container of claim 1, wherein the two or more discharge holes comprise at least one pair of diametrically opposed discharge holes.

3. (canceled)

4. The battery container of claim 1, wherein the battery housing is comprised of non-flammable material.

5. The battery container of claim 1, wherein the two or more discharge holes are configured to release expanding electrolyte of the battery.

6. The battery container of claim 1, wherein the opening of the battery housing is the only opening of the battery housing.

7. The battery container of claim 1, wherein the battery housing is comprised of steel.

8. (canceled)

9. A smoke detector comprising:
a battery container for a battery that is replaceable, the battery container comprising:
a battery housing configured to house the battery, the battery housing comprising an opening configured to receive the battery into the battery housing and allow the battery to be removed from the battery housing; and
an end cap configured to seal the opening of the battery housing, the end cap comprising two or more discharge holes formed through flat perimeter surfaces on sides of the end cap, spaced equally along the perimeter surfaces such that the radial spacing between each of the two or more discharge holes is equal, and configured to release expanding gas from the battery housing;
a circuit board including smoke detector electronics;
battery leads electrically coupled to the battery container and the circuit board; and
a smoke detector case to house the battery container, the circuit board, and the battery leads.

10. The smoke detector of claim 9, wherein the two or more discharge holes comprise at least one pair of diametrically opposed discharge holes.

11. (canceled)

12. The smoke detector of claim 9, wherein the battery housing is comprised of non-flammable material.

13. The smoke detector of claim 9, wherein the two or more discharge holes are configured to release expanding electrolyte of the battery.

14. The smoke detector of claim 9, wherein the opening of the battery housing is the only opening of the battery housing.

15. The smoke detector of claim 9, wherein the two or more discharge holes are configured to release expanding gas external to the smoke detector case.

16. The smoke detector of claim 9, further comprising a baseplate mechanically coupled to the smoke detector case, the baseplate configured to be mechanically coupled to an aircraft cargo container.

17. The smoke detector of claim 16, wherein the battery housing is mechanically coupled to the baseplate.

18. The smoke detector of claim 16, wherein the battery housing is formed monolithically to the baseplate.

19. The smoke detector of claim 9, wherein the battery housing is comprised of steel.

20. (canceled)
